(19) United States
(12) Patent Application Publication
(10) Pub. No.: US 2016/0255828 A1
(43) Pub. Date: Sep. 8, 2016

(54) PORTABLE HAND-HELD DEVICE FOR EMITTING A VOLATILE SUBSTANCE

(71) Applicant: Luis Alberto Cestino, Southwest Ranches, FL (US)

(72) Inventor: Luis Alberto Cestino, Southwest Ranches, FL (US)

(21) Appl. No.: 14/640,968

(22) Filed: Mar. 6, 2015

(51) Int. Cl. A01M 29/12; H05B 6/36; G01S 19/42; F21L 4/04; G01S 19/13; H05B 6/06; H04N 5/225

(52) U.S. Cl. CPC A01M 29/12; H05B 6/06; H05B 6/36; H04N 5/2257; H04N 5/2254; F21L 4/045; G01S 19/13; G01S 19/42

(57) ABSTRACT

A portable hand-held device for emitting a volatile substance that includes a housing shaped to fit substantially within a standard-sized clothing pocket, the housing including a plurality of housing walls defining an interior chamber. The interior chamber includes a heating zone having a heating element and a portable electrical power source electrically coupled to the heating element. The portable electrical power source is formed as at least one battery. A volatilization zone having a volatile substance carrier with a volatile substance therein is thermally coupled to the heating zone; and at least a portion of the volatilization zone is in fluid communication with an external environment surrounding the portable hand-held device. A thermally conductive plate is disposed between and in thermal communication with the heating element and the volatile substance; and is operably configured to support the volatile substance carrier on a heated surface thereof

### FIELD OF THE INVENTION

The present invention relates generally to a device for repelling insects, and more particularly, relates to a portable hand-held device for emitting a volatile substance.

### BACKGROUND OF THE INVENTION

It is well known that insects, such as mosquitoes and gnats, are bothersome, irritating, and often carry insect-borne diseases. Several existing insect repellants attempt to combat insects by applying an insect repellant, e.g., a volatile substance, directly to the skin or clothing of a user. These types of insect repellants come in a variety of forms, e.g., cream, lotion, aerosol spray, pump spray, and the like. Unfortunately, this type of insect repellant can irritate the skin and must be used with caution to avoid areas such as the user's eyes, lips, and mouth, as well as any cuts, wounds, etc. on the skin. These types of insect repellants may also produce a foul odor on the skin or clothing of the user.

Another existing insect repellant is the citronella candle containing citronella oil. Unfortunately, citronella oil repels insects for a short time period only. In addition, citronella candles pose a fire hazard and require constant monitoring. Citronella candles are also costly as citronella oil has a short lifespan that requires frequent replacement.

Portable electrical devices exist that utilize a fan to propel an insect repellant spray into the surrounding air. The portable electrical devices may be clipped onto the belt, pocket, or another area of a user. As the user travels, the fan may blow the insect repellant spray a distance from the user that is too far to provide an insect repelling benefit. Due to the fan constantly blowing the insect repellant spray, the insect repellant spray requires frequent replacement that is costly for the user.

Other existing insect repellants dispense chemicals into an ambient environment using a dispensing device. These insect repellants use an energy source, such as butane power, to heat a coil that causes a repelling chemical to evaporate into the air. Many of these existing insect repellants are bulky and inconvenient to carry, especially for those walking a great distance outdoors. Moreover, the heat produced by the energy source poses a burn risk and fire hazard to the user. In addition, the user is not provided with the option of adjusting the heat setting. As an added problem, the energy source, e.g., butane, lasts only a short time period. As a result, the butane and the associated padding requires constant replacement which is inconvenient and costly for the user.

Therefore, a need exists to overcome the problems with the prior art as discussed above.

### SUMMARY OF THE INVENTION

The invention provides a portable hand-held device for emitting a volatile substance that overcomes the hereinafore-mentioned disadvantages of the heretofore-known devices and methods of this general type and that

With the foregoing and other objects in view, there is provided, in accordance with the invention, a portable hand-held device for emitting a volatile substance, the portable hand-held device having a housing shaped to fit substantially within a standard-sized clothing pocket, the housing including a plurality of housing walls defining an interior chamber, the interior chamber including a heating zone with a heating element; and a portable electrical power source electrically coupled to the heating element, the portable electrical power source formed as at least one battery. The portable hand-held device further including a volatilization zone and a thermally conductive plate. The volatilization zone has a volatile substance carrier with a volatile substance therein; is thermally coupled to the heating zone; and at least a portion of the volatilization zone is in fluid communication with an external environment surrounding the portable hand-held device. The thermally conductive plate is disposed between and in thermal communication with the heating element and the volatile substance; and is operably configured to support the volatile substance carrier on a heated surface thereof.

In accordance with another feature of the present invention, a variable heat control is operably configured to transition a temperature of the heating element between at least two heating temperatures, the two heating temperatures including a high temperature and a maintenance temperature.

In accordance with a further feature of the present invention, the variable control includes a user interface operably configured to allow a user to transition the temperature of the heating element between the two heating temperatures.

In accordance with yet a further feature of the present invention, the variable control is operably configured to automatically transition the temperature of the heating element from the high temperature to the maintenance temperature after a time period.

In accordance with another feature of the present invention, the battery includes at least one rechargeable battery.

In accordance with yet another feature of the present invention, the volatile substance carrier is comprised of an absorbent material operable to absorb the volatile substance.

In accordance with a further feature of the present invention, the volatile substance carrier is formed as at least one of a cloth material, a pad, and an open-cell foam material.

In accordance with another feature of the present invention, the heating element is formed as a metallic coil.

In accordance with a further feature of the present invention, the heating element is formed as a metallic coil; the thermally conductive plate is formed as a metallic plate; and the heating element is disposed directly beneath the metallic plate.

In accordance with yet a further feature of the present invention, the portable hand-held device further includes a heat shield comprised of a non-thermally conductive material; segmenting the interior chamber within the housing into a heating chamber and a non-heating chamber, the heating chamber housing the heating zone and disposed a separation distance from the plurality of housing walls, the separation distance defined by dimensions of the non-heating chamber; and operably configured as a thermal barrier between the heating zone and the non-heating chamber.

In accordance with another feature of the present invention, the volatile substance includes an insect repellant.

In accordance with yet another feature of the present invention, the volatile substance includes an air treatment.

In accordance with yet another feature of the present invention, the portable hand-held device further includes a lower end; an upper end, opposite to the lower end; and a housing height of at most approximately 6 inches separating the lower end and the upper end.

In accordance with a further feature of the present invention, the portable hand-held device further includes a device for starting a fire, the device having an attachment end, attached to the housing; a heated end including a second heating element for starting the fire, the heated end opposite to the attachment end; and a flexible arm separating the attachment end from the heated end.

In accordance with yet a further feature of the present invention, the volatile substance carrier includes an amount of the volatile substance corresponding to a battery life of the battery.

In accordance with yet a further feature of the present invention, the portable hand-held device further includes a GPS unit for receiving GPS location information of the portable hand-held device, the GPS unit including a processor and a GPS receiver, the GPS receiver operably configured to receive GPS satellite signals and the processor operably configured to use the GPS satellite signals to generate a GPS map corresponding to the GPS location of the portable hand-held device; and a display for displaying the GPS map to a user, the display communicatively coupled to the processor and the display and GPS unit together disposed within the housing and outside of the heating zone.

In accordance with a further feature of the present invention, the portable hand-held device further includes a camera operably configured to capture still images and video, the camera disposed within the housing and outside of the heating zone and the camera including a lens defining an external surface of the housing.

In accordance with a further feature of the present invention, the portable hand-held device further includes a flashlight with an attachment end, attached to the housing; an illumination end, opposite to the attachment end; and a flexible repositionable arm separating the illumination end from the attachment end, the flexible repositionable arm operably configured to allow a user to reposition the illumination end in a plurality of orientations relative to the attachment end.

In accordance with another feature, an embodiment of the present invention includes a portable hand-held survival device with a housing shaped to fit substantially within a standard-sized clothing pocket, the housing including a plurality of housing walls defining an interior chamber, the interior chamber including a heating zone having a heating element; and a portable electrical power source electrically coupled to the heating element, the portable electrical power source formed as at least one rechargeable battery. The portable hand-held survival device also includes a volatilization zone, a metallic plate, and a heat shield. The volatilization zone has a volatile substance carrier with a volatile substance therein, the volatile substance carrier made of a material operable to absorb the volatile substance and the volatile substance including an insect repellant; thermally coupled to the heating zone; and at least a portion of the volatilization zone in fluid communication with an external environment surrounding the portable hand-held device. The metallic plate is disposed directly above the heating element and directly beneath the volatile substance carrier; is in thermal communication with the heating element and the volatile substance; and is operably configured to support the volatile substance carrier on a heated surface thereof. The heat shield is made of a non-thermally conductive material; is segmenting the interior chamber within the housing into a heating chamber and non-heating chamber, the heating chamber housing the heating zone and disposed a separation distance from the plurality of housing walls, the separation distance defined by dimensions of the non-heating chamber; and is operably configured as a thermal barrier between the heating zone and the non-heating chamber. A variable heat control, also included in the portable hand-held survival device, is operably configured to transition a temperature of the heating element between at least two heating temperatures, the two heating temperatures including a high temperature and a maintenance temperature.

Although the invention is illustrated and described herein as embodied in a portable hand-held device for emitting a volatile substance it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one.

The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the portable hand-held device for emitting a volatile substance from a lower end closest to a ground surface toward an upper end. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is an elevational front view of a portable hand-held device for emitting a volatile substance in accordance with the present invention;

FIG. 2 is an elevational side view of the portable hand-held device for emitting a volatile substance of FIG. 1;

FIG. 3 is an elevational front view of the portable hand-held device for emitting a volatile substance of FIG. 1 showing an interior chamber;

FIG. 4 is a cross sectional view of the interior chamber along section A-A, depicting a volatile substance carrier, a thermally conductive plate, and a heating element, in accordance with the present invention;

FIG. 5 is an elevational front view of a portable hand-held device for emitting a volatile substance having a fire-starting device and a GPS display;

FIG. 6 is an elevational side view of the portable hand-held device for emitting a volatile substance of FIG. 5 in accordance with an exemplary embodiment of the present invention;

FIG. 7 is a block diagram of an exemplary GPS unit, in accordance with the present invention;

FIG. 8 is an elevational front view of a portable hand-held device for emitting a volatile substance having a GPS display;

FIG. 9 is an elevational side view of the portable hand-held device for emitting a volatile substance of FIG. 8;

FIG. 10 is an elevational side view of the portable hand-held device for emitting a volatile substance of FIG. 8;

FIG. 11 is an elevational front view of another exemplary embodiment of a portable hand-held device for emitting a volatile substance in accordance with the present invention;

FIG. 12 is an elevational side view of the portable hand-held device for emitting a volatile substance of FIG. 11 having a flashlight; and

FIG. 13 is an elevational rear view the portable hand-held device for emitting a volatile substance of FIG. 11 having a camera lens.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient portable hand-held device for emitting a volatile substance. The term “volatile substance” is defined herein as a substance capable of evaporating and which contains an active ingredient that is effective in repelling, deterring, or killing insects. Embodiments of the invention include the portable hand-held device for emitting a volatize substance having a portable electric power source, such as a rechargeable battery. The portable electric power source activates a heating element to heat a volatile substance carrier containing a volatile substance, e.g., insect repellant, so as to volatilize the volatile substance into the surrounding air. In addition, embodiments of the invention provide a user with the ability to control the temperature of the heating element, as well as engage a plurality of survival features, e.g., a GPS unit, a camera, and a flashlight, for use during outdoor activities.

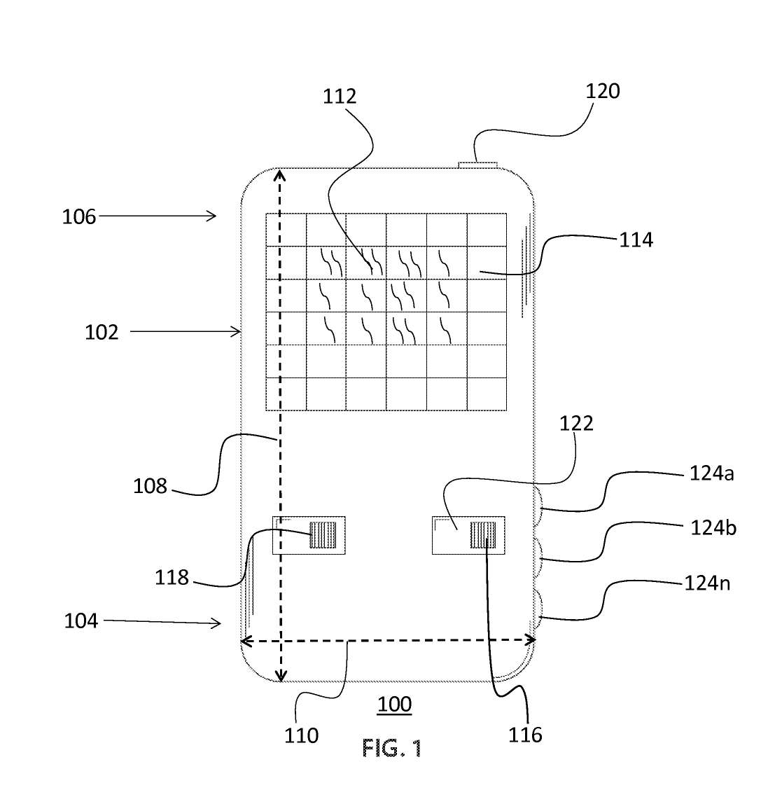

Referring now to FIG. 1, one embodiment of the present invention is shown in an elevational front view. FIG. 1 shows several advantageous features of the present invention, but, as will be described below, the invention can be provided in several shapes, sizes, combinations of features and components, and varying numbers and functions of the components. The first example of a portable hand-held device for emitting a volatile substance 100 (hereinafter referred to as the “portable hand-held device”), as shown in FIG. 1, includes a housing 102. In one embodiment, the housing 102 is shaped to fit substantially within a standard-sized clothing pocket. The term “substantially” is defined herein as fitting at least three-fourths of the way into a standard-sized clothing pocket, such that there is little to no risk of the portable hand-held device 100 falling out. Advantageously, the housing 102 may be sized and shaped for convenient and easy carrying by a user, such as during outdoor activities, e.g., picnics, park outings, camping, fishing, hunting, and hiking The portable hand-held device 100 may also be used by military personnel.

In one embodiment, as depicted in FIG. 1, the housing 102 includes a lower end 104 and an upper end 106 located opposite to the lower end 104. A housing height 108 separates the lower end 104 and the upper end 106. In one embodiment, the housing height 108 is a maximum height of approximately 6 inches. Said another way, a maximum housing height 108 of 6 inches separates the lower end 104 from the upper end 106. In this embodiment, the housing 102 may include a housing width 110 that is a maximum of 4 inches.

In another embodiment, the portable hand-held device 100 is sized and shaped to exceed the dimensions of a standard-sized clothing pocket. In this embodiment, the housing height 108 is greater than 6 inches and the housing width 110 is greater than 4 inches. In this embodiment, the portable hand-held device 100 may be used to repel insects in an outdoor area surrounding more than one user, such as during a picnic or a sporting event.

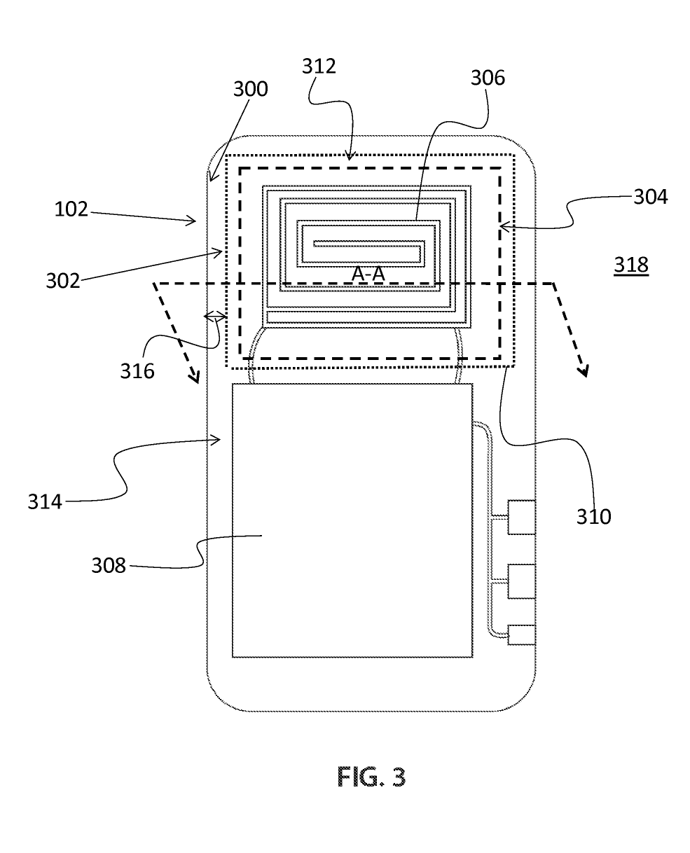

With reference primarily to FIG. 1, in conjunction with FIG. 3, the housing 102 includes a plurality of housing walls 300 defining an interior chamber 302. FIG. 3 depicts a front elevational view of the interior chamber 302. The interior chamber 302 is depicted having a heating zone 304 that includes a heating element 306. The housing walls 300 are made of a material capable of withstanding the heat generated by the heating element 306. The heating element 306 may be circular, square, rectangular, or another shape. In a preferred embodiment, the heating element 306 is formed in substantially the same shape as a volatile substance carrier 114 (FIG. 1) that is in thermal communication with the heating element 306. In one embodiment, the heating element 306 is formed as a metallic coil. In another embodiment, the heating element 306 may be made with be an alternative alloy, ceramic, aluminum, or the like.

In one embodiment, the heating zone 304 is located above a portable electric power source 308 that is electrically coupled to the heating element 306. In one embodiment, the portable electric power source 308 is formed as at least one battery that may be replaceable or rechargeable. The rechargeable battery may have a continued run time of at least twelve hours. In another embodiment, the portable electric power source 308 may be a solar panel or an alternate portable electric power source. The portable electric power source 308 activates the heating element 306 which volatizes a volatile substance 112 (FIG. 1), e.g., an insect repellant, from the volatile substance carrier 114 (FIG. 1) into the surrounding air. The term “volatile” is defined herein as passing off readily in the form of vapor. The portable hand-held device 100 may also be operably configured to disperse an air treatment, e.g., an air freshener, into the surrounding air. The air treatment may emit scents such as vanilla, cinnamon, pine, cherry, and the like.

In order to sufficiently protect the electronic components from the heating components, the portable hand-held device 100 includes a heat shield 310. The heat shield 310 is made of a non-thermally conductive material. In one embodiment, the heat shield 310 is made of a non-thermally conductive polymer-based material. In another embodiment, the heat shield 310 is made of a non-thermally conductive glass material. The heat shield 310 segments the interior chamber 302 within the housing 102 into a heating chamber 312 and a non-heating chamber 314. The heating chamber 312 houses the heating zone 304 and is disposed a separation distance 316 from the plurality of housing walls 300. The separation distance 316 is defined by the dimensions of the non-heating chamber 314. The heat shield 310 is operably configured as a thermal barrier between the heating zone 304 and the non-heating chamber 314.

With reference again to FIG. 1, the volatile substance carrier 114 is comprised of an absorbent material operable to absorb the volatile substance. The volatile substance carrier 114 is formed as at least one of a cloth material, a pad, and an open-cell foam material. In one embodiment, the volatile substance carrier 114 includes a shelf life that is equivalent to the shelf life of the portable electric power source 308, e.g., the battery. In another embodiment, the volatile substance carrier may be replaced following a number of hours of usage, e.g., twelve to fifteen hours of usage.

FIG. 1 depicts the portable hand-held device 100 having a variable heat control 116 operably configured to transition a temperature of the heating element 306 between at least two heating temperatures. The term “heating temperature” is defined herein as the degree of heat present when the heating element 306 (FIG. 3) of the portable hand-held device 100 is in an on mode. A first power control button 118 turns the heating element 306 from an on mode to an off mode and vice versa. A second power control button 120 turns the portable hand-held device 100 from an on mode to an off mode and vice versa.

In one embodiment, the two heating temperatures include a high temperature and a maintenance temperature. The high temperature is a temperature that is hot enough to heat the heating element 306 (FIG. 3) so as to volatize the volatile substance into the surrounding air to repel the insects from a desired area surrounding a user. The desired area around the user may be up to approximately 20 feet×20 feet. In use, once a sufficient amount of the volatile substance has been emitted so as to effectively repel the insects from the desired area around the user, the portable hand-held device 100 can be placed at the maintenance temperature. The maintenance temperature is a temperature that is cooler than the high temperature, yet hot enough to maintain the volatizing effect.

The high temperature and the maintenance temperature may vary, depending on the vapor pressure of the volatile substance. Naturally, the volatile substance having a higher vapor pressure vaporizes more readily than a substance with a lower vapor pressure. In one embodiment, the high temperature may be approximately 150° C. to 280° C. and the maintenance temperature may be approximately 50° C. to 149° C. In other embodiments, the temperatures may vary outside of these ranges. Advantageously, the ability to reduce the temperature to the maintenance temperature reduces the amount of heat generated by the portable hand-held device 100, resulting in improved battery life and an overall reduction in expenses associated with replacing the volatile substance carrier 114, the volatile substance 112, and other associated components.

The variable heat control 116 may be manually or automatically controlled. In one embodiment, in order to manually control the variable heat control 116, a user interface 122 is operably configured to allow a user to transition the temperature of the heating element 306 (FIG. 3) between the two heating temperatures. In another embodiment, the variable heat control 116 may automatically transition the temperature of the heating element from the high temperature to the maintenance temperature after a time period, e.g., approximately ten to thirty minutes, through the use of an automatic control feature, such as an automatic timer or a sensor. In other embodiments, there may be more than two heating temperatures.

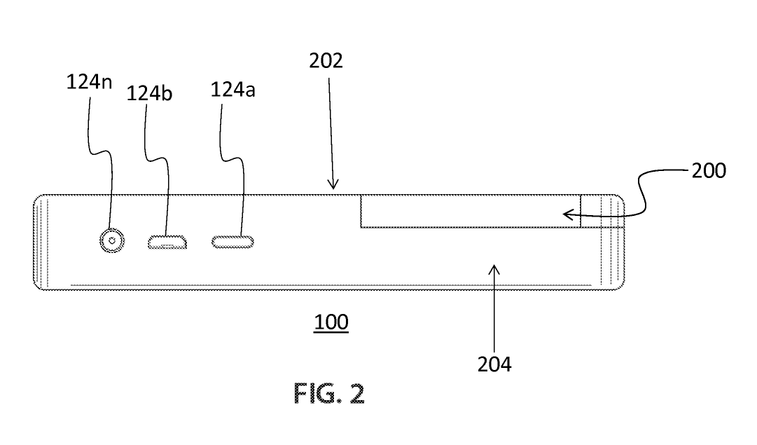

FIGS. 1 and 2 depict the portable hand-held device 100 having a plurality of charging ports 124a-n. FIG. 2 is an elevational side view of the portable hand-held device 100. The charging ports 124a-n are operably configured to allow a user to charge the portable electric power source 308 (FIG. 3) using various portable electronic devices, e.g., cellular phones, tablets, etc. The indicator “a-n” is intended to represent any number of items, with “a” indicating 1 and “n” indicating any number greater than 1. The charging ports 124a-n may also be configured to connect to a vehicle power port or wall outlet as sources of power to charge the portable electric power source 308 (FIG. 3). As an added advantage, the charging ports 124a-n may be configured to connect to a portable solar power charger for use in a remote location where electricity is unavailable, as is often the case during outdoor activities.

FIG. 2 depicts the portable hand-held device 100 having a volatile substance carrier receptacle 200 sized and shaped to receive the volatile substance carrier 114 (FIG. 1) therein. The volatile substance carrier receptacle 200 may be accessed by opening at least one of a top portion 202 and a side portion 204 of the portable hand-held device 100 for easy and convenient removal and replacement of the volatile substance carrier 114 (FIG. 1). The user may unscrew, open, detach, or otherwise access the volatile substance carrier 114 through at least one of the top portion 202 and the side portion 204. In one embodiment, the user can insert the volatile substance carrier 114 into the volatile substance carrier receptacle 200, where the volatile substance carrier 114 is frictionally retained within the volatile substance carrier receptacle 200, or otherwise securely attached therein.

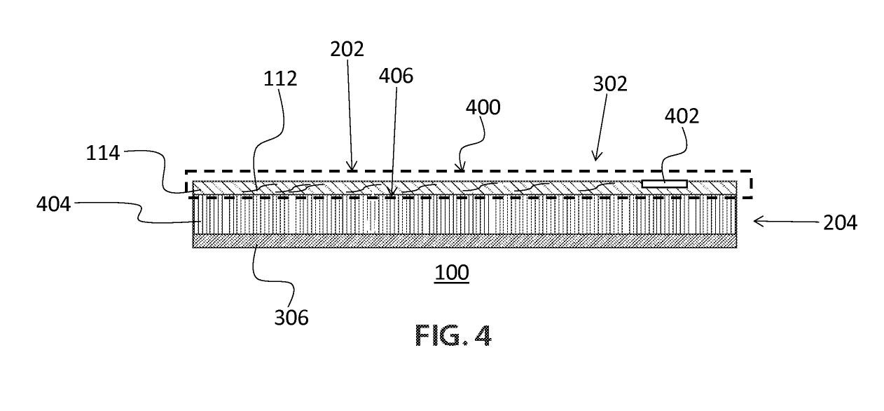

With reference to FIG.3, primarily in conjunction with FIG. 4, the portable hand-held device 100 includes a volatilization zone 400. FIG. 4 is a cross sectional view of the interior chamber along section A-A as shown in FIG. 3. The volatilization zone 400 includes the volatile substance carrier 114 having the volatile substance 112 therein, thermally coupled to the heating zone 304 (FIG. 3). At least a portion 402 of the volatilization zone 400 is in fluid communication with an external environment 318 surrounding the portable hand-held device 100. The portion 402 allows the volatile substance 112 to escape from the interior chamber 302 into the surrounding external environment 318 to repel the insects in the surrounding area. In one embodiment, the portion 402 is located along the top portion 202 above the volatile substance carrier 114, as depicted in FIG. 4. In another embodiment, the portion 402 may be located along the side portion 204 (FIG. 2) of the portable hand-held device 100.

FIG. 4 depicts a thermally conductive plate 404 disposed between and in thermal communication with the heating element 306 and the volatile substance carrier 114. The thermally conductive plate 404 is operably configured to support the volatile substance carrier 114 on a heated surface 406 of the thermally conductive plate 404. In one embodiment, the thermally conductive plate 404 is formed as a metallic plate. In another embodiment, the material of the thermally conductive plate 404 is another alloy, aluminum, ceramic or the like. In one embodiment, as depicted in FIG. 4, the heating element 306 is disposed directly beneath the thermally conductive plate 404, i.e., the metallic plate. Said another way, the thermally conductive plate 404, e.g., the metallic plate, may be disposed directly above the heating element 306 and directly beneath the volatile substance carrier 114. The term “directly” is defined herein as having nothing in between.

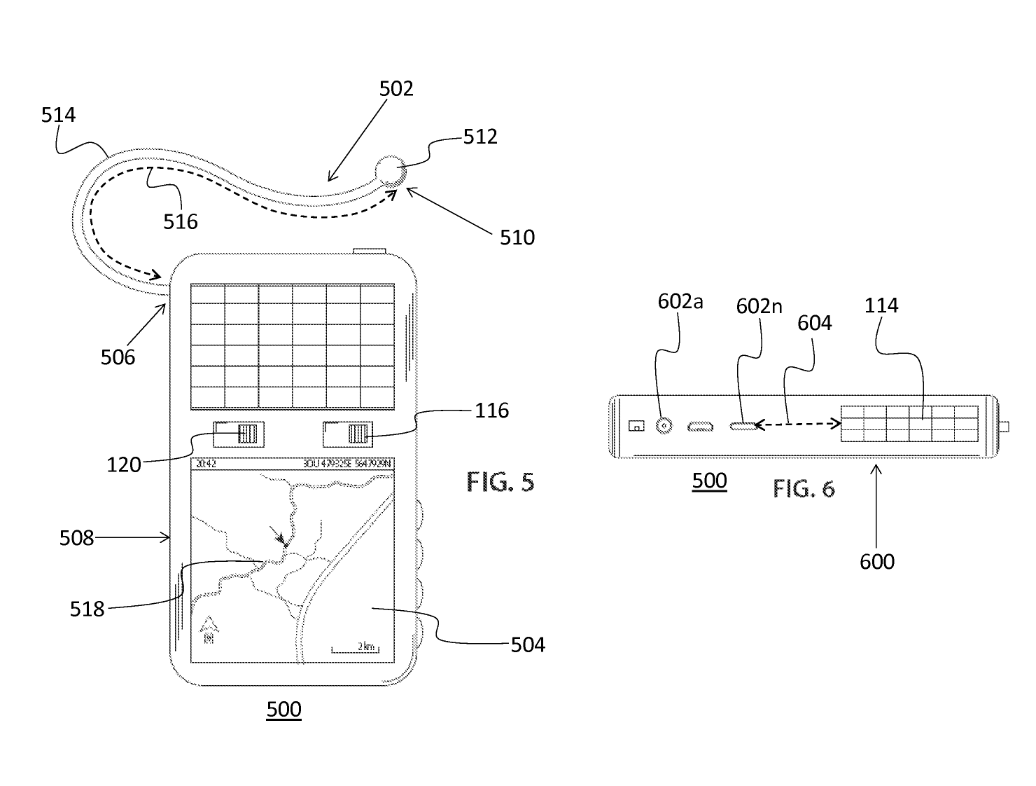

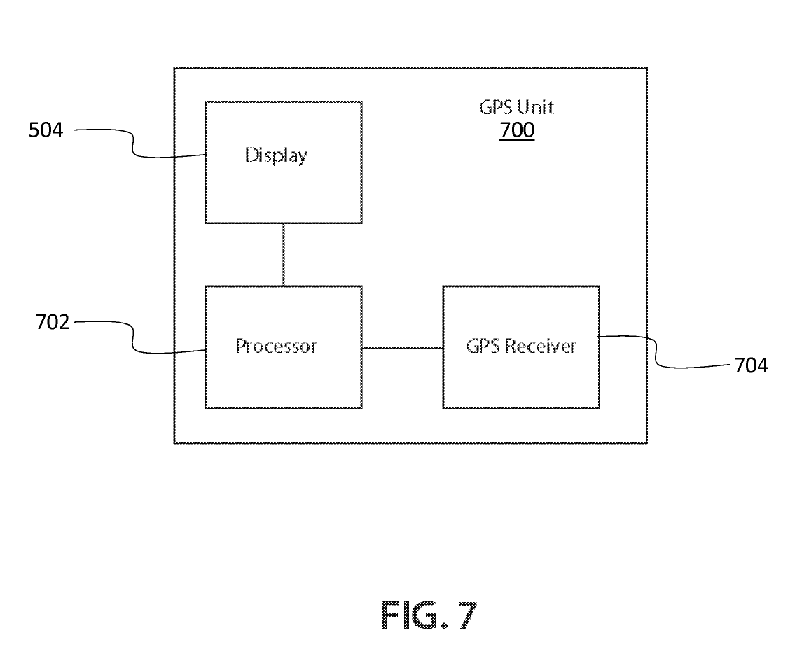

With reference now to FIG. 5, another embodiment of the portable hand-held device 500, i.e. a portable hand-held survival device, is shown. In this embodiment, the portable hand-held device 500 includes various features which serve as survival tools for a user. For example, the portable hand-held device 500 includes a fire-starting device 502 for starting a fire and a display 504 for communication with a GPS unit 700 (FIG. 7). Advantageously, the fire-starting device 502 serves as a survival tool by providing a user with the ability to conveniently start a fire during outdoor activities, such as camping. As such, the user does not have to carry a separate lighter or matches in order to start a fire. The GPS unit 700 (FIG. 7) provides the user with step-step directions to a desired destination based on the location of the portable hand-held device 500. The GPS unit 700 also serves as a safety feature by allowing emergency personnel to determine the location of the portable hand-held device 500.

FIG. 5 depicts the fire-starting device 502 having an attachment end 506 attached to a housing 508. In one embodiment, the attachment end 506 is removably attached to the housing 508. As such, the fire-starting device 502 can be easily and conveniently replaced, following normal wear and tear, or can be removed by the user when desired. In another embodiment, the attachment end 506 may be permanently attached to the housing 508. The attachment end 506 may be attached to the housing 508 by a bolt, screw, nail, or other attachment mechanism.

The fire-starting device 502 further includes a heated end 510 including a second heating element 512 for starting the fire. The heated end 510 is located opposite to the attachment end 506. The attachment end 506 is separated from the heated end 510 by a flexible arm 514. In one embodiment, the flexible arm 514 is a cord. In another embodiment, the flexible arm 514 is a wire lead. In other embodiments, the flexible arm 514 may be another flexible member. In further embodiments, the arm is not limited to being flexible, but rather may form a rigid member protruding from the housing 508. In one embodiment, the flexible arm 514 includes a length 516 of eight to twelve inches. In other embodiments, the length 516 may be outside of this range. In one embodiment, the second heating element 512, i.e., ignition source, is steel, for example, high carbon steel, firesteel, or the like. In another embodiment, the second heating element 512 may be iron, metal, or another type of conductive ignition source.

With reference to FIG. 5, primarily in conjunction with FIG. 7, the GPS unit 700 is operably configured to receive GPS location information of the portable hand-held device 500. The GPS unit 700 includes a processor 702 and a GPS receiver 704. The GPS receiver 704 is operably configured to receive GPS satellite signals. The processor 702 is operably configured to use the GPS satellite signals to generate a GPS map 518 (FIG. 5) corresponding to the GPS location of the portable hand-held device 500. The portable hand-held device 500 includes the display 504 for displaying the GPS map 518 to the user. The display 504 is depicted underneath the volatile substance carrier 114. FIG. 5 depicts the GPS map 518 viewed on the display 504. FIG. 7 depicts the display 504 communicatively coupled to the processor 702. The display 504 and the GPS unit 700 together are disposed within the housing 508 (FIG. 5) and outside of the heating zone (FIG. 3).

In one embodiment, the portable hand-held device 500 is configured to operate a plurality of apps to enhance the existing functionality of the portable hand-held device 500. In one embodiment, the portable hand-held device 500 includes a network interface. The network interface is operably configured to communicate via the Internet to download apps and communicate with app-hosting servers. The portable hand-held device 500 may include an emergency app that sends out an emergency signal through the GPS unit 700 or the network interface. The network interface may include, for example, a radio frequency (RF) transceiver, and a network interface card, such as a Wi-Fi network interface card. In one embodiment, the network interface may include a wide area network (WAN) interface, which may permit a connection to a cellular mobile communications network. The WAN interface may include communications circuitry, such as an antenna coupled to a radio circuit having a transceiver for transmitting and receiving radio signals via the antenna. The radio circuit may be configured to operate in a mobile communications network, including but not limited to global systems for mobile communications (GSM), code division multiple access (CDMA), wideband CDMA (WCDMA), and the like.

FIG. 6 is an elevational side view of the portable hand-held device 500 having a volatile substance carrier 114 positioned along a side 600 of the portable hand-held device 500. An additional volatile substance carrier 114 may be positioned along an alternate side of the portable hand-held device 500. For example, the portable hand-held device 500 may include a single volatile substance carrier 114 on a right side and a single volatile substance carrier 114 on a left side. Advantageously, such placement allows the portable hand-held device 500 to emit the volatile substance 112 from each side, thereby covering a great surface area for repelling insects surrounding the user. As an added benefit, the volatile substance carrier 114 does not come into contact with the display 504 (FIG. 5). FIG. 6 depicts a plurality of charging ports 602a-n positioned a distance 604 from the volatile substance carrier 114 such that the charging ports 602a-n are not in contact with the volatile substance carrier 114.

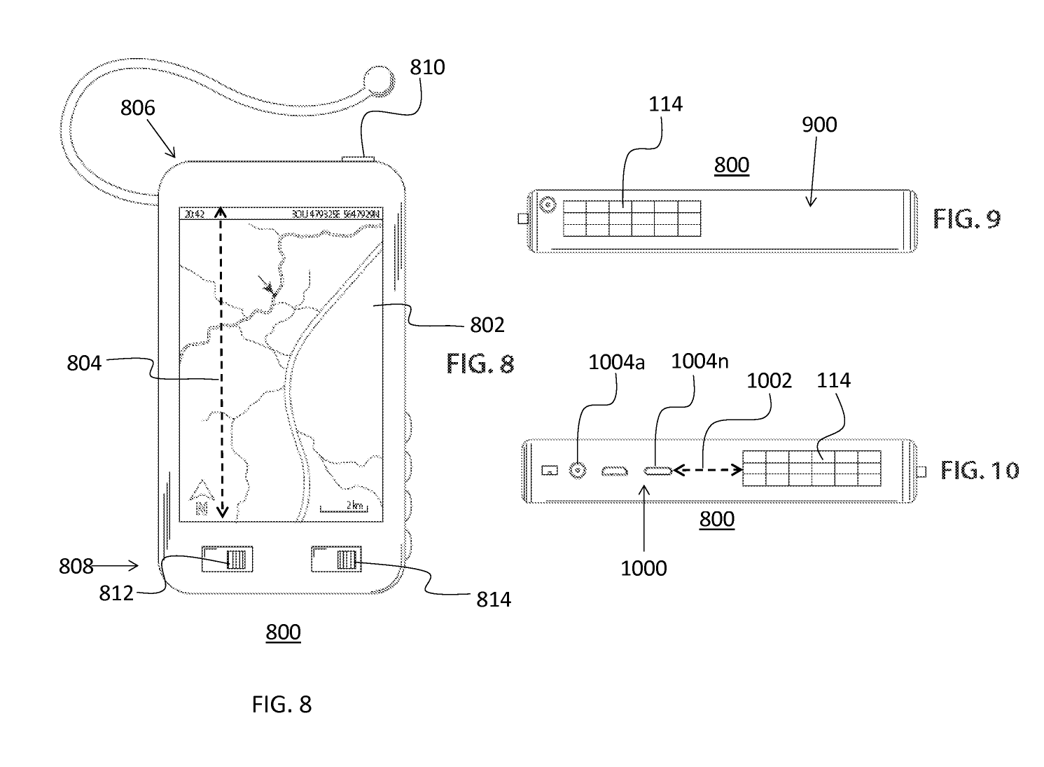

With reference to FIG. 8, another embodiment of the portable hand-held device 800 is shown. As opposed to the configurations above depicting the volatile substance carrier 114 from a front view of the portable hand-held device 100, 500, FIG. 8 depicts an elevational front view of the portable handle-held device 800 having a display 802 operably configured to display a GPS map, additional features associated with apps downloaded by the user via the portable hand-held device 800, or the like. The display 802 is depicted spanning a length 804 of the portable hand-held device 800 from a upper end 806 of the portable hand-held device 800 to a lower end 808 of the portable hand-held device 800. The upper end 806 includes a first power control button 810. The lower end 808 includes a second power control button 812 and a variable control button 814. The display 802 is positioned above the buttons 812, 814, so as not to come into contact with the heating features of the portable hand-held device 800.

With reference to FIG. 8, primarily in conjunction with FIG. 9, a single volatile substance carrier 114 is positioned along a side 900 (FIG. 9) of the portable hand-held device 800, so as not to come into contact with the display 802 (FIG. 8). In a similar fashion, FIG. 10 depicts the volatile substance carrier 114 positioned along a second side 1000 and of the portable hand-held device 800. The volatile substance carrier 114 is placed a distance 1002 away from a plurality of charging ports 1004a-n so as not to come into contact with the charging ports 1004a-n.

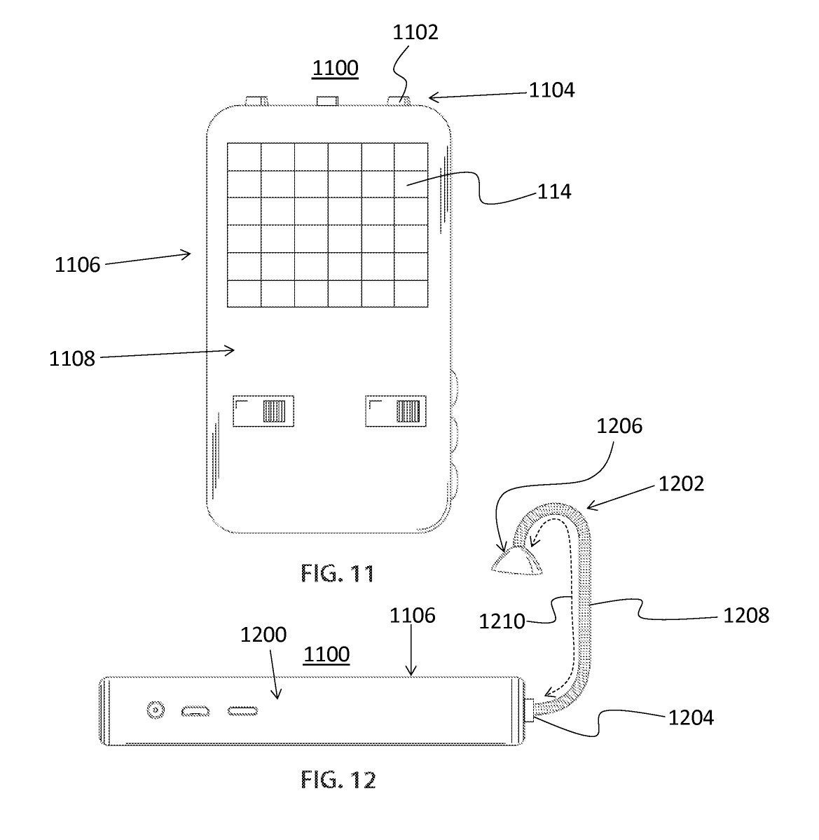

With reference now to FIGS. 11 through 13, another embodiment of the portable hand-held device 1100 is shown in a front elevational view, a side elevational view, and a rear elevational view, respectively. FIG. 11 depicts the portable hand-held device 1100 having a light source 1102 positioned on an upper section 1104 of a housing 1106. The light source 1102 may be an LED light bulb, a standard light bulb, a solar powered bulb, or another light source 1102 for emitting light. Advantageously, the light source 1102 may act as a flashlight to guide a user in a dark area during outdoor activities. The portable hand-held device 1100 depicts at least a portion of the volatile substance carrier 114 disposed on a front surface 1108 of the portable hand-held device 1100.

FIG. 12 depicts a side portion 1200 of the portable hand-held device 1100 having a flashlight 1202. The flashlight 1202 includes an attachment end 1204 attached to the housing 1106 and an illumination end 1206 opposite to the attachment end 1204. FIG. 12 depicts the flashlight 1202 having a flexible repositionable arm 1208 separating the illumination end 1206 from the attachment end 1204. In one embodiment, the flexible repositionable arm 1208 is operably configured to allow a user to reposition the illumination end 1206 in a plurality of orientations relative to the attachment end 1204.

In one embodiment, the flexible repositionable arm 1208 is a cable or another flexible repositionable member. In further embodiments, the arm is not limited to being flexible, but rather may form a rigid member protruding from the housing 1106. In one embodiment, the flexible repositionable arm 1208 includes a length 1210 of six to eight inches. In other embodiments, the length 1210 may be outside of this range.

Although the arm 1208 is described as “flexible” and “repositionable,” the arm 1208 is intended to be rigid enough to maintain its repositioned shape, without requiring additional support. For example, a user may position the flexible repositionable arm 1208 in a forward direction away from and parallel to the housing in a first position. This first position would direct light in a forward direction and the flexible repositionable arm 1208 would maintain this first position in a rigid manner, until the user applies a sufficient force to reposition the flexible repositionable arm 1208 in a second position, different from the first position, such as, for example, an upright position, as illustrated in FIG. 12. In a preferred embodiment, the flexible repositionable arm 1208 can be repositioned in a multitude of configurations and orientations in order to allow the user to project light in a multitude of directions and orientations.

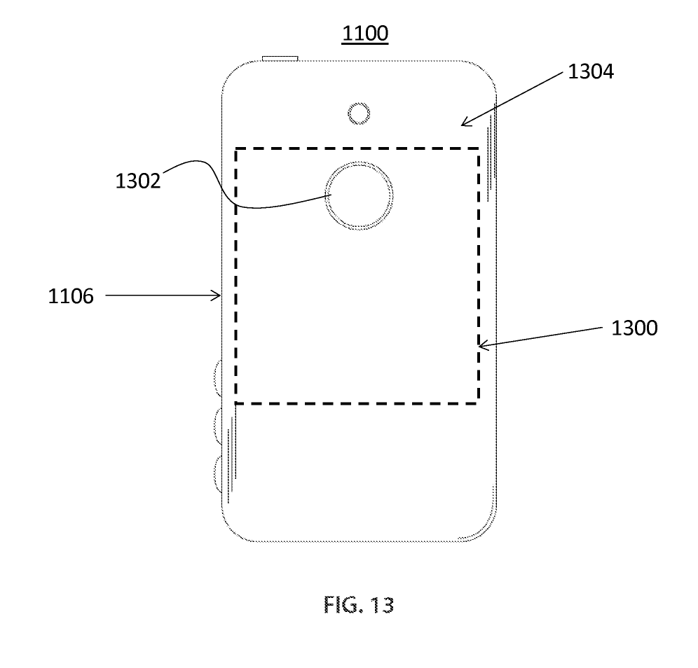

FIG. 13 depicts the portable hand-held device 1100 having a camera 1300 operably configured to capture still images and video. The camera 1300 is disposed within the housing 1106 and outside of the heating zone 304 (FIG. 3). The camera 1300 includes a lens 1302 defining an external surface 1304 of the housing 1106.

A portable hand-held device for emitting a volatile substance has been disclosed that features a housing shaped to fit substantially within a standard-sized clothing pocket. Other features of the invention have been disclosed that provide a heating zone including a heating element and a portable electrical power source, such as a battery, electrically coupled to the heating element.

What is claimed is:

1. A portable hand-held device for emitting a volatile substance, the portable hand-held device comprising:
a housing shaped to fit substantially within a standard-sized clothing pocket, the housing including a plurality of housing walls defining an interior chamber, the interior chamber including:
a heating zone including a heating element;
a portable electrical power source electrically coupled to the heating element, the portable electrical power source formed as at least one battery;
a volatilization zone:
including a volatile substance carrier with a volatile substance therein;
thermally coupled to the heating zone; and
at least a portion of the volatilization zone in fluid communication with an external environment surrounding the portable hand-held device;
a thermally conductive plate:
disposed between and in thermal communication with the heating element and the volatile substance; and
operably configured to support the volatile substance carrier on a heated surface thereof.

2. The portable hand-held device in accordance with claim 1, further comprising:
a variable heat control operably configured to transition a temperature of the heating element between at least two heating temperatures, the at least two heating temperatures including a high temperature and a maintenance temperature.

3. The portable hand-held device in accordance with claim 2, wherein:
the variable control includes a user interface operably configured to allow a user to transition the temperature of the heating element between the at least two heating temperatures.

4. The portable hand-held device in accordance with claim 2, wherein:
the variable control is operably configured to automatically transition the temperature of the heating element from the high temperature to the maintenance temperature after a time period.

5. The portable hand-held device in accordance with claim 1, wherein:
the at least one battery is at least one rechargeable battery.

6. The portable hand-held device in accordance with claim 1, wherein:
the volatile substance carrier is comprised of an absorbent material operable to absorb the volatile substance.

7. The portable hand-held device in accordance with claim 1, wherein:
the volatile substance carrier is formed as at least one of a cloth material, a pad, and an open-cell foam material.

8. The portable hand-held device in accordance with claim 1, wherein:
the heating element is formed as a metallic coil.

9. The portable hand-held device in accordance with claim 1, wherein:
the heating element is formed as a metallic coil;
the thermally conductive plate is formed as a metallic plate; and
the heating element is disposed directly beneath the metallic plate.

10. The portable hand-held device in accordance with claim 1, further comprising:
a heat shield:
comprised of a non-thermally conductive material;
segmenting the interior chamber within the housing into a heating chamber and a non-heating chamber, the heating chamber housing the heating zone and disposed a separation distance from the plurality of housing walls, the separation distance defined by dimensions of the non-heating chamber; and
operably configured as a thermal barrier between the heating zone and the non-heating chamber.

11. The portable hand-held device in accordance with claim 1, wherein:
the volatile substance includes an insect repellant.

12. The portable hand-held device in accordance with claim 1, wherein:
the volatile substance includes an air treatment.

13. The portable hand-held device in accordance with claim 1, further comprising:
a lower end;
an upper end, opposite to the lower end; and
a housing height of at most approximately 6 inches separating the lower end and the upper end.

14. The portable hand-held device in accordance with claim 1, further comprising:
a device for starting a fire:
having an attachment end, attached to the housing;
a heated end including a second heating element for starting the fire, the heated end opposite to the attachment end; and
a flexible arm separating the attachment end from the heated end.

15. The portable hand-held device in accordance with claim 1, wherein:
the volatile substance carrier includes an amount of the volatile substance corresponding to a battery life of the at least one battery.

16. The portable hand-held device in accordance with claim 1, further comprising:
a GPS unit for receiving GPS location information of the portable hand-held device, the GPS unit including a processor and a GPS receiver, the GPS receiver operably configured to receive GPS satellite signals and the processor operably configured to use the GPS satellite signals to generate a GPS map corresponding to the GPS location of the portable hand-held device; and
a display for displaying the GPS map to a user, the display communicatively coupled to the processor and the display and GPS unit together disposed within the housing and outside of the heating zone.

17. The portable hand-held device in accordance with claim 1, further comprising:
a camera operably configured to capture still images and video, the camera disposed within the housing and outside of the heating zone and the camera including a lens defining an external surface of the housing.

18. The portable hand-held device in accordance with claim 1, further comprising:
a flashlight including:
an attachment end, attached to the housing;
an illumination end, opposite to the attachment end; and
a flexible repositionable arm separating the illumination end from the attachment end, the flexible repositionable arm operably configured to allow a user to reposition the illumination end in a plurality of orientations relative to the attachment end.

19. A portable hand-held survival device, the device comprising:
a housing shaped to fit substantially within a standard-sized clothing pocket, the housing including a plurality of housing walls defining an interior chamber, the interior chamber including:
a heating zone having a heating element;
a portable electrical power source electrically coupled to the heating element, the portable electrical power source formed as at least one rechargeable battery;
a volatilization zone:
including a volatile substance carrier with a volatile substance therein, the volatile substance carrier comprised of a material operable to absorb the volatile substance and the volatile substance including an insect repellant;
thermally coupled to the heating zone; and
at least a portion of the volatilization zone in fluid communication with an external environment surrounding the portable hand-held device;
a metallic plate:
disposed directly above the heating element and directly beneath the volatile substance carrier;
in thermal communication with the heating element and the volatile substance; and
operably configured to support the volatile substance carrier on a heated surface thereof;
a heat shield:
comprised of a non-thermally conductive material;
segmenting the interior chamber within the housing into a heating chamber and non-heating chamber, the heating chamber housing the heating zone and disposed a separation distance from the plurality of housing walls, the separation distance defined by dimensions of the non-heating chamber; and
operably configured as a thermal barrier between the heating zone and the non-heating chamber; and
a variable heat control operably configured to transition a temperature of the heating element between at least two heating temperatures, the at least two heating temperatures including a high temperature and a maintenance temperature.

20. The portable hand-held survival device in accordance with claim 19, further comprising:
a GPS unit for receiving GPS location information of the portable hand-held device, the GPS unit including a processor and a GPS receiver, the GPS receiver operably configured to receive GPS satellite signals and the processor operably configured to use the GPS satellite signals to generate a GPS map corresponding to the GPS location of the portable hand-held device;
a display for displaying the GPS map to a user, the display communicatively coupled to the processor and the display and GPS unit together disposed within the housing and outside of the heating zone;
a camera operably configured to capture still images and video, the camera disposed within the housing and outside of the heating zone and the camera including a lens defining an external surface of the housing; and
a flashlight including:
an attachment end, attached to the housing;
an illumination end, opposite to the attachment end; and
a flexible repositionable arm separating the illumination end from the attachment end, the flexible repositionable arm operably configured to allow a user to reposition the illumination end in a plurality of orientations relative to the attachment end.
